(19) United States
(12) Patent Application Publication
(10) Pub. No.: US 2010/0039828 A1
(43) Pub. Date: Feb. 18, 2010

(54) DIFFUSION PLATE

(76) Inventors: Byeong Heui Han, Yongin-si (KR); Yoon Hee Cho, Yongin-si (KR); Hee Cheong Lee, Yongin-si (KR)

Correspondence Address: SUGHRUE MION, PLLC, 2100 PENNSYLVANIA AVENUE, N.W., SUITE 800, WASHINGTON, DC, 20037, US

(21) Appl. No.: 12/526,722

(22) PCT Filed: Feb. 12, 2008
(86) PCT No.: PCT/KR08/00820

§ 371 Date: Aug. 11, 2009

(30) Foreign Application Priority Data
Feb. 16, 2007 (KR) 10 2007 0016311

(51) Int. Cl. F21V 11/00

(52) U.S. Cl. 362/355

(57) ABSTRACT

Disclosed is a light diffusion plate for use in a backlight unit of a liquid crystal display or an illumination apparatus, which includes polycarbonate resin or polystyrene resin as a base resin, so that appropriate brightness and high hiding properties or appropriate hiding properties and high brightness are exhibited, and thus, while minimizing the use of additional optical films, brightness is sufficiently high, therefore maintaining good light emission quality. The diffusion plate has high ability to hide a light source, is inexpensively manufactured, and has high dimensional stability, so that no curling occurs even under high-temperature and high-humidity conditions, leading to excellent light properties.

### TECHNICAL FIELD

The present invention relates to a light diffusion plate for use in a backlight unit of a liquid crystal display or an illumination apparatus.

### BACKGROUND ART

As industrial society has developed toward an advanced information age, the importance of electronic displays as a medium for displaying and transferring various pieces of information is increasing day by day. Conventionally, a CRT (Cathode Ray Tube), which is bulky, was widely used therefor, but is considerably limited in terms of the space required to mount it, thus making it difficult to manufacture CRTs having larger sizes. Accordingly, CRTs are being replaced with various types of flat panel displays, including liquid crystal displays (LCDs), plasma display panels (PDPs), field emission displays (FEDs), and organic electroluminescent displays. Among such flat panel displays, in particular, LCDs, as a technologically intensive product resulting from a combination of liquid crystal-semiconductor techniques, are advantageous because they are thin and light and consume little power. Therefore, research and development into structures and manufacturing techniques thereof has continued. Nowadays, LCDs, which have already been applied in fields such as notebook computers, monitors for desktop computers, and portable personal communication devices (PDAs and mobile phones), are manufactured to be larger, and thus, it is possible to apply LCDs to large-sized TVs, such as HD (High-Definition) TVs. Thereby, LCDs are receiving attention as novel displays able to substitute for CRTs which were a synonym for displays.

In the LCDs, because liquid crystals themselves cannot emit light, an additional light source is provided at the back surface thereof so that the intensity of light passing through the liquid crystals in each pixel is controlled to realize contrast. More specifically, the LCD, serving as a device for adjusting light transmittance using the electrical properties of liquid crystal material, emits light from a light source lamp at the back surface thereof, and, in order to maximize luminous efficiency, light thus emitted is passed through various functional sheets or films to thus cause light to be uniform and directional, after which such controlled light is also passed through a color filter, thereby realizing red, green, and blue (R, G, B) colors. Furthermore, the LCD is of an indirect light emission type, which realizes an image by controlling the contrast of each pixel through an electrical method. As such, a light-emitting device provided with the light source is regarded as important in determining the quality of the image of the LCD, including brightness and uniformity.

The light-emitting device typically includes a light source, a reflection plate, a light guide plate, a reflective high-brightness film, a prism film, a light diffusion film, and a light diffusion plate. Various types of plates or films are used, so that as much light as possible reaches the liquid-crystal device from the light source.

Among them, the light diffusion plate simultaneously functions to cause the brightness of light emitted from the light source lamp to be uniform and to hide the bright lines of the lamp, and furthermore, plays a role as a support for the other optical films. The light diffusion plate is added with various light-diffusing agents, thus causing the refraction, scattering, and reflection of light, leading to diffusion effects.

In order to transmit much light toward the front surface from the light diffusion plate, various films including the light diffusion film or the prism film should be mounted. However, attributable to the addition of such multilayer materials, the manufacturing costs are increased and productivity is decreased.

The light diffusion film functions to effectively diffuse incident light and to transmit light toward the front surface while assisting the hiding performance of the diffusion plate. Generally, the light diffusion film includes a transparent substrate and a diffusion layer, the diffusion layer being formed on the surface of the transparent substrate. The diffusion layer includes spherical material particles, acting as a scattering agent, and the diffusion effect of the light diffusion film is realized by the difference in refractive index between the binder of the diffusion layer and the scattering agent contained in the binder. Because the scattering agent is dispersed in the diffusion layer, when light is passed through the diffusion layer, it propagates while continuously reciprocally moving between two media having different refractive indexes.

Moreover, with the goal of transmitting much light through the light diffusion film toward the front surface, the prism film should be provided, but is problematic in that it is expensive and deteriorates productivity.

### DISCLOSURE

### Technical Problem

Accordingly, the present invention provides a light diffusion plate having a single layer structure, which exhibits appropriate brightness and superior hiding properties.

In addition, the present invention provides a light diffusion plate having a multilayer structure, which exhibits appropriate brightness and superior hiding properties.

In addition, the present invention provides a light diffusion plate having a single layer structure, which exhibits sufficient brightness through adjustment of total light transmittance while maintaining hiding properties.

In addition, the present invention provides a light diffusion plate having a multilayer structure, which exhibits sufficient brightness through adjustment of total light transmittance while maintaining hiding properties.

In addition, the present invention provides a light diffusion plate, in which the type and amount of light-diffusing agent are adjusted, thus maximizing brightness of a display.

In addition, the present invention provides a light diffusion plate, in which the LCD manufacturing cost is decreased, thus generating economical benefits.

In addition, the present invention provides a light diffusion plate, which has high dimensional stability so that no curling phenomenon occurs even under high-temperature and high-humidity conditions, and which exhibits superior light-diffusing properties.

### Technical Solution

According to a first embodiment of the present invention, there is provided a light diffusion plate, composed of a base resin selected from among polycarbonate resin, polystyrene resin, and mixtures thereof and having a pattern layer formed on at least one surface thereof, with total light transmittance of 40% or more and brightness of 4500 cd/mm².

According to a second embodiment of the present invention, there is provided a light diffusion plate, comprising a substrate layer formed of a base resin selected from among polycarbonate resin, polystyrene resin, and mixtures thereof; a surface layer formed on at least one surface of the substrate layer; and a pattern layer formed on at least one surface of the surface layer, with total light transmittance of 40% or more and brightness of 4500 cd/mm².

According to a third embodiment of the present invention, there is provided a light diffusion plate, composed of a base resin selected from among polycarbonate resin, polystyrene resin, and mixtures thereof, with haze of 90% or less and total light transmittance of 80% or more.

According to a fourth embodiment of the present invention, there is provided a light diffusion plate, comprising a substrate layer formed of a base resin selected from among polycarbonate resin, polystyrene resin, and mixtures thereof; and a surface layer formed on at least one surface of the substrate layer, with haze of 90% or less and total light transmittance of 80% or more.

The light diffusion plate according to the first to fourth embodiments of the present invention may further comprise a light-diffusing agent having a particle size of 100 μm or less.

In the light diffusion plate according to the first to fourth embodiments of the present invention, the light-diffusing agent may be one or more selected from among acrylic polymer particles; styrene polymer particles; olefin polymer particles; acryl and styrene copolymer particles; acryl and olefin copolymer particles; styrene and olefin copolymer particles; multilayer multicomponent particles, obtained by forming homopolymer, copolymer or terpolymer particles, which are then coated with another type of monomer; siloxane polymer particles; fluorine resin particles; calcium carbonate particles; barium sulfate particles; silicon oxide particles; aluminum hydroxide particles; titanium oxide particles; zirconium oxide particles; magnesium fluoride particles; talc particles; glass particles; and mica.

The light diffusion plate according to the third and fourth embodiments of the present invention may further comprise a pattern layer formed on at least one surface thereof.

In the light diffusion plate according to the first to fourth embodiments of the present invention, the pattern layer may comprise a plurality of patterns having a polyhedral shape, a cross-section of which is polygonal, semicircular, or semi-elliptical, or a column shape, a cross-section of which is polygonal, semicircular, or semi-elliptical, and the patterns may be respectively arranged to be adjacent to each other or not.

In the light diffusion plate according to the first to fourth embodiments of the present invention, the polystyrene resin may have a glass transition temperature of 105° C. or higher.

In the light diffusion plate according to the first to fourth embodiments of the present invention, the polystyrene resin may be a polystyrene resin in which acrylic acid is copolymerized.

### ADVANTAGEOUS EFFECTS

According to an aspect of the present invention, the light diffusion plate exhibits sufficient brightness and superior hiding properties, thus making it possible to sufficiently hide the image of a light source even when applied to a backlight unit having a large screen, and has high dimensional stability so that less curling occurs even under high-temperature and high-humidity conditions.

In addition, according to another aspect of the present invention, the light diffusion plate has high total light transmittance and sufficiently high brightness, thus maintaining good light emission quality. Hence, the light diffusion plate minimizes the use of optical films, thus decreasing the manufacturing cost thereof, and further, has high dimensional stability, so that less curling occurs even under high-temperature and high-humidity conditions.

### DESCRIPTION OF DRAWINGS

FIG. 1 is a perspective view illustrating the diffusion plate according to a first embodiment of the present invention;

FIG. 2 is a perspective view illustrating the diffusion plate according to a second embodiment of the present invention;

FIG. 3 is a perspective view illustrating the diffusion plate according to a third embodiment of the present invention; and

FIG. 4 is a perspective view illustrating the diffusion plate according to a fourth embodiment of the present invention.

### DESCRIPTION OF THE REFERENCE NUMERALS IN THE DRAWINGS

10: substrate layer 20: surface layer
30, 40, 50, 60: pattern layer

### BEST MODE

Hereinafter, a detailed description will be given of the present invention.

According to the present invention, a light diffusion plate having a single layer structure or a multilayer structure is provided, and exhibits appropriate brightness and superior hiding properties. Such a light diffusion plate is composed of a base resin, including polycarbonate resin and polystyrene resin, which may be used alone or in mixtures thereof.

The polycarbonate resin has excellent impact resistance and light transmittance and good low-temperature resistance and electrical properties, and furthermore, has high heat resistance and absorption resistance, and thus the dimensional stability thereof is very high. Accordingly, the polycarbonate resin is usable in a wide temperature range, and is thus employed for optical lenses, optical disk materials, helmets, protectors, covers, etc.

The polycarbonate resin used in the present invention includes, as typical aromatic polycarbonate resin, linear and branched carbonate homopolymers, polyester copolymers, and mixtures thereof, obtained by reacting dihydroxy phenol with phosgene or reacting dihydroxy phenol with a carbonate precursor. Examples of the dihydroxy phenol includes 2,2-bis(4-hydroxyphenyl)propane (bisphenol A), bis(4-hydroxyphenyl)methane, 2,2-bis(4-hydroxy-3,5-dimethylphenyl)propane, and 1,1-bis(4-hydroxyphenyl)cyclohexane, and examples of the carbonate precursor includes diphenyl carbonate, carbonyl halide, and diaryl carbonate.

The polycarbonate resin has a melt index (MI) of 7˜30 g/10 min under conditions of 300° C. and a load of 1.2 kg according to ASTM D1238.

As the base resin, in the case where the polystyrene resin is used alone, examples having a glass transition temperature of 105° C. or higher may be used to increase heat resistance, and include polystyrene resin in which acrylic acid is copolymerized.

Because the polystyrene resin is rigid, colorless and transparent, has good electrical properties, and is inexpensive thanks to mass production, it is used in various fields, including daily articles, such as kitchen parts, stationery materials, and furniture, large molded parts for vehicles, and electrical appliances such as television cabinets.

As the base resin, in the case where the mixture of polycarbonate resin and polystyrene resin is used, polystyrene resin having an MI of 0.5˜3 g/10 min under conditions of 200° C. and a load of 5 kg according to ASTM D1238 may be used.

In the case where the mixture of polycarbonate resin and polystyrene resin is used, it may be melt-mixed at a molding temperature of 200˜300° C., and preferably 250° C., at a motor speed of 250 rpm, using a twin screw extruder having a diameter of 30 mm.

In the case where polycarbonate resin and polystyrene resin are mixed, they may be mixed at a weight ratio of 1:9˜9:1, in order to realize the advantages of polycarbonate, including flexibility and dimensional stability, and the advantages of polystyrene, including absorption resistance and strength.

Alternatively, in the present invention, the light diffusion plate may have a multilayer structure comprising a substrate layer and a surface layer on either or both surfaces thereof.

The composition of the surface layer is not particularly limited, and, for instance, the base resin for the surface layer includes a styrene-acrylic copolymer resin obtained by copolymerizing an acrylic monomer with a styrene monomer.

Useful as the monomers, the acrylic monomer includes one or more selected from among methacrylic acid alkyl ester, acrylic acid alkyl ester, methacrylic acid cycloalkyl ester, acrylic acid cycloalkyl ester, methacrylic acid aryl ester, and acrylic acid aryl ester, and the styrene monomer includes styrene or substituted styrene. The substituted styrene includes alkyl styrene such as α-methylstyrene, halogenated styrene such as chlorostyrene, and vinyl styrene. In addition, a combination of two or more styrene monomers may be used, depending on the need.

In particular, in the case where the styrene-acrylic copolymer resin is used, the ratio of acrylic monomer and styrene monomer which are to be copolymerized ranges from 6:4 to 1:9, in consideration of the force of adhesion to the substrate layer.

The light diffusion plate according to the present invention may further include a pattern layer on at least one surface thereof, the pattern layer functioning to maintain appropriate brightness while improving hiding properties.

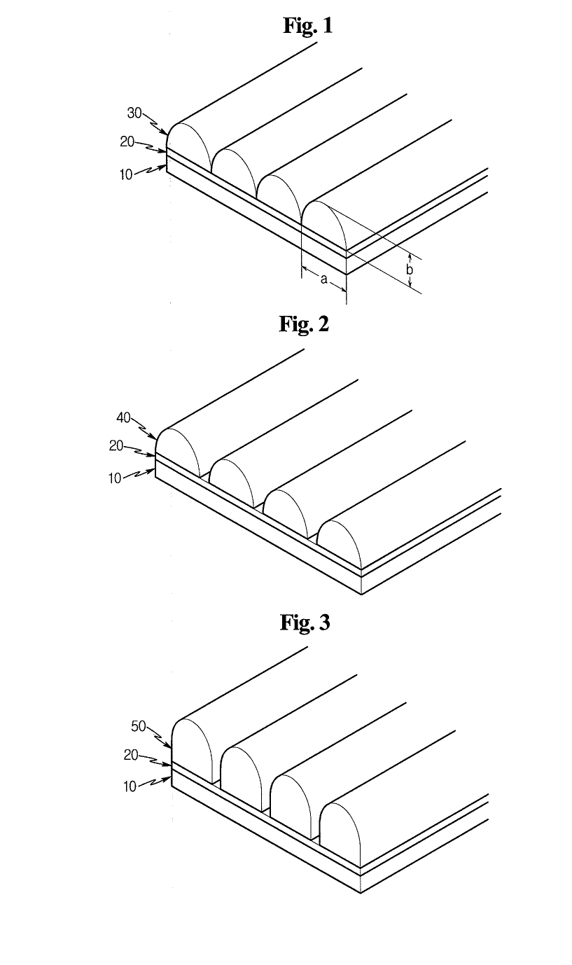

The pattern layer has a plurality of patterns, and the patterns each have a polyhedral shape, the cross-section of which is polygonal, semicircular, or semi-elliptical, or a column shape, the cross-section of which is polygonal, semicircular, or semi-elliptical, or alternatively, a combination of one or more shapes may be applied. Also, the patterns may be respectively arranged to be adjacent to each other or not. The pattern layer is illustrated in FIGS. 1 to 4.

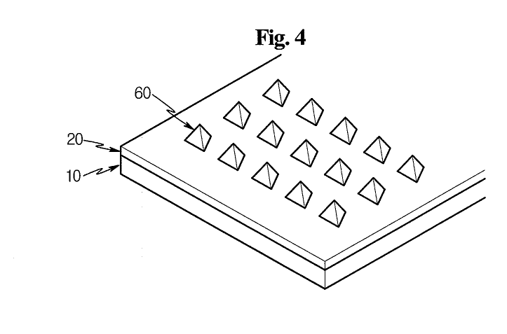

FIG. 1 illustrates the light diffusion plate including a substrate layer and a surface layer, and further including a pattern layer composed of columns which have a semicircular cross-section and are linearly arranged on one surface of the surface layer, and FIG. 2 illustrates the light diffusion plate, in which a pattern layer is composed of columns, the cross-section of which is semicircular and which are arranged at predetermined intervals. FIG. 3 illustrates the light diffusion plate, in which a pattern layer is composed of columns, the cross-section of which is a modified semicircle, and which are arranged at predetermined intervals. FIG. 4 illustrates the light diffusion plate, in which a pattern layer is composed of pyramid-shaped tetrahedrons, the cross-section of which is trigonal and which are arranged at predetermined intervals.

In this way, the pattern layer is further formed on the substrate layer and/or the surface layer, so that a light path is controlled and diffused light is transmitted toward the front surface, thereby maintaining brightness appropriately and improving the ability to hide the image of the light source.

According to the embodiment of the present invention, the light diffusion plate has total light transmittance of 40% or more and brightness of 4500 cd/mm² or more.

In the case of satisfying such total light transmittance and brightness, the light diffusion plate has superior hiding properties and appropriate brightness, and may thus be applied to the backlight unit of an LCD having a large area, thereby effectively hiding the image of the light source.

While the invention has been disclosed as above with reference to the drawings which are set forth to illustrate, but are not to be construed to limit the invention, it will be understood by those skilled in the art that various changes can be made thereto without departing from the technical spirit of the invention.

In the case where the light diffusion plate includes the surface layer formed on either or both surfaces of the substrate layer, a known process, such as co-extrusion molding, lamination, thermal adhesion, or surface coating, may be conducted.

In the case where the light diffusion plate includes the pattern layer, a known process, such as lamination, thermal adhesion, roll transfer, film transfer, press transfer, or printing, may be conducted.

In addition, the present invention provides a light diffusion plate, which satisfies appropriate hiding properties and high brightness and thus considerably decreases the use of optical films, and may be achieved even in the absence of the pattern layer, as mentioned above.

Used herein, the base resin, the multilayer structure through the formation of additional surface layer, and the specific composition of the surface layer are as defined above.

In this case, the light diffusion plate has haze of 90% or less and total light transmittance of 80% or more, and exhibits appropriate hiding properties and high brightness, and thus, the number of additional optical films may be decreased. In particular, the diffusion plate is very useful as a diffusion film for a backlight unit having an appropriate area.

Depending on the need, in order to further increase hiding properties and increase brightness, the aforementioned pattern layer may be further provided.

In the embodiments related to the light diffusion plate according to the present invention, a light-diffusing agent may be used. The light-diffusing agent typically has a refractive index different from that of the base resin and is used to increase the diffusion rate of light, and is responsible for imparting appropriate hiding properties, transmittance, and diffusion properties.

The light-diffusing agent includes various organic and inorganic particles, and typical examples of the organic particles include acrylic polymer particles, such as methylmethacrylate, ethylmethacrylate, isobutylmethacrylate, n-butylmethacrylate, n-butylmethylmethacrylate, acrylic acid, methacrylic acid, hydroxyethylmethacrylate, hydroxypropylmethacrylate, hydroxyethylacrylate, acryl amide, methylol acryl amide, glycidyl methacrylate, ethylacrylate, isobutylacrylate, n-butylacrylate, 2-ethylhexylacrylate, and polymers, copolymers or terpolymers thereof; styrene polymer particles, such as styrene, substituted styrene, and polymers, copolymers or terpolymers thereof; olefin polymer particles, such as polyethylene and polypropylene; acryl and styrene copolymer particles; acryl and olefin copolymer particles; styrene and olefin copolymer particles; multilayer multicomponent particles, obtained by forming the homopolymer, copolymer, or terpolymer particles, which are then coated with another type of monomer; siloxane polymer particles; and fluorine resin particles.

Examples of the inorganic particles include calcium carbonate, barium sulfate, silicon oxide, aluminum hydroxide, titanium oxide, zirconium oxide, magnesium fluoride, talc, glass, and mica. The organic particles have light-diffusing properties superior to the inorganic particles, and a combination of two or more light-diffusing agents may be used, depending on the need.

In the case where there is a large difference in refractive index between the light-diffusing agent and the base resin, a light diffusion effect may be exhibited even when the light-diffusing agent is used in a small amount. Conversely, in the case where there is a small difference in refractive index therebetween, the light-diffusing agent should be used in a relatively large amount.

Conventionally, brightness is considered to increase as the amount of light-diffusing agent is increased. However, when the light-diffusing agent is used in too large an amount, brightness may be rather decreased. Thus, the amount of light-diffusing agent is adjusted so that appropriate hiding properties and high brightness are exhibited.

The light diffusion plate, the hiding properties and brightness of which are adjusted, may be obtained through various methods below, which may be used alone or in combinations thereof.

A first method includes adjusting the amount of light-diffusing agent in consideration of a difference in refractive index between a base resin and a light-diffusing agent, a second method includes, in the case of a multilayer structure, adjusting the amount of a light-diffusing agent of a substrate layer and a surface layer, a third method includes adjusting the type of light-diffusing agent, and a fourth method includes adjusting the size of the light-diffusing agent.

For example, in the case where the amount of light-diffusing agent is 10 parts by weight or less based on 100 parts by weight of the base resin, a light diffusion plate having a haze of 90% or less and total light transmittance of 80% or more may be manufactured. In the case where a pattern layer is further provided, total light transmittance is further decreased, thus increasing hiding properties and exhibiting appropriate brightness.

In the case where the light-diffusing agent is used in the surface layer, the amount of light-diffusing agent should vary depending on the refractive index with the base resin for the surface layer and the amount of light-diffusing agent of the substrate layer, and may be set to 20 parts by weight or less, based on 100 parts by weight of the base resin for the surface layer.

The light-diffusing agent may have a particle size of 100 μm or less.

In addition, the light diffusion plate according to the present invention may be further added with a process stabilizer, a UV absorber, or a UV stabilizer, depending on the need.

### MODE FOR INVENTION

A better understanding of the present invention may be obtained through the following examples, which are set forth to illustrate, but are not to be construed as the limit of the present invention.

### Examples 1˜12

The compositions and composition ratios of Examples 112 are shown in Table 1 below.

The polycarbonate resin that is used has an MI of 22 g/10 min under conditions of 300° C. and a load of 1.2 kg according to ASTM D1238.

In the present examples, as the base resin, in the case where polycarbonate and polystyrene are used in a mixture form, they are added at the composition ratio shown in Table 1, and are then melt-mixed using a twin screw extruder at 250° C.

The polystyrene resin used has an MI of 1.5 g/10 min under conditions of 200° C. and a load of 5 kg according to ASTM D1238.

As the base resin for the surface layer, a typical styrene-acrylic copolymer resin according to the composition of Table 1 was used.

In the composition of the light diffusion plate, the substrate layer was composed of a base resin and a light-diffusing agent according to the composition of Table 1, and 0.5 parts by weight of a UV absorber as a light stabilizer, for example, B-Cap (tetraethyl-2,2′-(1,4-phenylene-dimethylidene)-bismalonate), and the surface layer was composed of a base resin and a light-diffusing agent according to the composition of Table 1, and 2 parts by weight of a UV absorber as a light stabilizer, for example, B-Cap (tetraethyl-2,2′-(1,4-phenylene-dimethylidene)-bismalonate).

The pattern layer composed of columns having a semicircular cross-section with a pitch (a) of 150 μm and a height (b) of 75 μm was formed through roll coating on the upper surface of the plate (FIG. 1).

Specifically, Examples 1˜4 are related to the diffusion plate having a single layer structure, without the surface layer, Examples 5˜8 are related to the diffusion plate including a substrate layer and a surface layer formed on one surface thereof, and Examples 9˜12 are related to the diffusion plate including a substrate layer and a surface layer having the same composition as in Examples 5˜8, with the exception that the surface layer was formed on both surfaces thereof.

For molding, co-extrusion was conducted using a single screw extruder having a diameter of 135 mm and 60 mm, and molding temperatures were 250° C. and 220° C. In Examples 1˜4, the thickness of the substrate layer was 2.0 mm, in Examples 5˜8, the thickness of the substrate layer was 1.9 mm and the thickness of the surface layer was 0.1 mm, and in Examples 9˜12, the thickness of the substrate layer was 1.8 mm and the thickness of the surface layer was 0.1 mm at both sides.

TABLE 1

| | Substrate | | | Surface | | |
|---|---|---|---|---|---|---|
| | Layer (wt part) | | | Layer (wt part) | | |
| | | | MM Resin | | MM Resin | Pattern |
| Ex. | PC | PS | Beads | MS | Beads | Layer |
| 1 | 800 | 200 | 1 | — | — | X |
| 2 | 200 | 800 | 1 | — | — | X |
| 3 | 800 | 200 | 1 | — | — | ◯ |
| 4 | 200 | 800 | 1 | — | — | ◯ |
| 5, 9 | 800 | 200 | — | 100 | 7 | X |
| 6, 10 | 200 | 800 | — | 100 | 7 | X |
| 7, 11 | 800 | 200 | — | 100 | 7 | ◯ |
| 8, 12 | 200 | 800 | — | 100 | 7 | ◯ |

PC: polycarbonate (reaction product of 2,2-bis(4-hydroxyphenyl)propane and phosgene), LG Dow, Calibre 300-22
PS: polystyrene, Toyo Styrene, HRM40
MS: styrene-acrylate copolymer resin, Nippon Steel Chemical, MS600
MM resin beads: methylmethacrylate resin beads, Kolon, M-10P

The light diffusion plates manufactured in the examples were measured for total light transmittance, haze, brightness, curling, water absorption and thermal modification temperature. The results are shown in Table 2 below.

The total light transmittance and haze were measured according to ASTM D1003, and the brightness was measured using LS-100, available from Minolta.

The curling was determined in a manner such that the diffusion plate was mounted to a backlight unit having a size of 20″ and was then allowed to stand at 60° C. and relative humidity of 75% for 96 hours, after which the distance between four corners of the diffusion plate, which were curled upward, and the surface of the backlight unit was measured. The water absorption was determined in a manner such that the light diffusion plate was cut to a size of 10 cm×10 cm, and was then allowed to stand in water at 25° C. for 24 hours, after which the change in weight thereof was measured. The thermal deformation temperature was measured according to ASTM D648.

TABLE 2

| | Total Light | | | | | |
|---|---|---|---|---|---|---|
| | Transmit- | | Bright- | | Water | Thermal |
| | tance | Haze | ness | Curling | Absorption | Deformation |
| Ex. | (%) | (%) | (cd/m²) | (mm) | (%) | Temp. (° C.) |
| 1 | 92.1 | 75.0 | 4864 | 0.20 | 0.19 | 123.1 |
| 2 | 91.9 | 79.0 | 4789 | 0.14 | 0.14 | 101.5 |
| 3 | 91.4 | 77.0 | 5771 | 0.21 | 0.20 | 121.9 |
| 4 | 90.1 | 81.0 | 5649 | 0.15 | 0.16 | 100.1 |
| 5 | 93.1 | 75.3 | 4971 | 0.20 | 0.18 | 119.3 |
| 6 | 93.9 | 75.9 | 4923 | 0.15 | 0.13 | 99.6 |
| 7 | 93.9 | 78.1 | 5917 | 0.21 | 0.19 | 118.1 |
| 8 | 93.6 | 77.9 | 5896 | 0.17 | 0.14 | 98.9 |
| 9 | 94.4 | 77.4 | 5071 | 0.18 | 0.17 | 117.1 |
| 10 | 94.1 | 78.1 | 5050 | 0.13 | 0.12 | 97.6 |
| 11 | 94.1 | 79.6 | 6005 | 0.20 | 0.17 | 115.9 |
| 12 | 94.5 | 79.1 | 5967 | 0.16 | 0.13 | 97.0 |

As is apparent from Table 2, all of the plates of the examples had very high total light transmittance of 90% or more and superior brightness. Further, dimensional stability thereof was also high. In particular, the plates of Examples 3, 4, 7, 8, 11, and 12, having the pattern layer, had higher brightness than the other plates having no pattern layer. In Examples 2, 4, 6, 8, 10, 12, in which the amount of PS of the substrate layer was larger than that of PC thereof, lower water absorption and thermal deformation temperature were exhibited than when using PC larger than PS, and furthermore, the curling was relatively decreased.

The light diffusion plates of Examples 1, 2, 5, 6, 9, and 10 were measured for the ability to hide the lamp. Specifically, the light diffusion plate was mounted to a 24″ backlight unit, after which a diffusion film, a prism film, and a reflective polarization film were sequentially placed thereon, and then whether the image of the lamp could be observed with the naked eye was evaluated. The case where the image was not visible was determined to be good, whereas the case where the image was visible was determined to be poor. As the results, the ability to hide the lamp was good.

The light diffusion plates of Examples 3, 4, 7, 8, 11, and 12, having the pattern layer, were measured for the ability to hide the lamp. Specifically, the light diffusion plate was mounted to a 32″ backlight unit, after which a diffusion film, a prism film, and a reflective polarization film were sequentially placed thereon, and then whether the image of the lamp could be observed with the naked eye was evaluated. The case where the image was not visible was determined to be good, whereas the case where the image was visible was determined to be poor.

As the results, the ability to hide the lamp was good.

### Examples 13˜18

Light diffusion plates were manufactured to the same dimensions and in the same manner as in Examples 1˜12, with the exception that, as the base resin of the substrate layer, only polystyrene resin (having a glass transition temperature of 115° C.) in which acrylic acid was partially copolymerized was used, and the surface layer was formed on one surface of the substrate layer, in Examples 15 and 16, and the surface layer was formed on both surfaces of the substrate layer, in Examples 17 and 18.

The specific compositions are shown in Table 3 below.

TABLE 3

| | |
|---|---|
| Substrate | Surface Layer |
| Layer (wt part) | (wt part) |

| | | MM Resin | | MM Resin | Pattern |
|---|---|---|---|---|---|
| Ex. | PS | Beads | MS | Beads | Layer |
| 13 | 1000 | 1 | — | — | X |
| 14 | 1000 | 1 | — | — | ◯ |
| 15, 17 | 1000 | — | 100 | 7 | X |
| 16, 18 | 1000 | — | 100 | 7 | ◯ |

PS: polystyrene, Toyo Styrene, T080
MS: styrene-acrylate copolymer resin, Nippon Steel Chemical, MS600
MM resin beads: methylmethacrylate resin beads, Kolon, M-10P

The light diffusion plates thus obtained were measured for total light transmittance, haze, brightness, curling, water absorption and thermal modification temperature. The results are shown in Table 4 below.

TABLE 4

| | Total Light | | | | | |
|---|---|---|---|---|---|---|
| | Transmit- | | Bright- | | Water | Thermal |
| | tance | Haze | ness | Curling | Absorption | Deformation |
| Ex. | (%) | (%) | (cd/m²) | (mm) | (%) | Temp. (° C.) |
| 13 | 89.6 | 75.8 | 4752 | 0.15 | 0.16 | 110.2 |
| 14 | 88.4 | 79.5 | 5621 | 0.16 | 0.17 | 110.1 |
| 15 | 90.1 | 76.4 | 4816 | 0.15 | 0.15 | 109.8 |
| 16 | 90.5 | 79.6 | 5746 | 0.16 | 0.17 | 109.4 |
| 17 | 90.3 | 77.8 | 4953 | 0.17 | 0.17 | 110.3 |
| 18 | 90.8 | 78.6 | 5865 | 0.16 | 0.16 | 109.9 |

As is apparent from Table 4, in the case where the polystyrene resin satisfying predetermined thermal properties was used alone, total light transmittance, haze, and curling were not changed, and dimensional stability was the same as when using the mixture with polycarbonate resin.

### Examples 19˜24

Light diffusion plates were manufactured to the same dimensions and in the same manner as in Examples 1˜12, with the exception that, as the type of diffusion beads, silicon beads were used instead of the acrylic resin beads, and the surface layer was formed on one surface of the substrate layer, in Examples 21 and 22, and was formed on both surfaces of the substrate layer, in Examples 23 and 24. The specific compositions are shown in Table 3 below.

TABLE 5

| | Substrate | | | Surface Layer | | |
|---|---|---|---|---|---|---|
| | Layer (wt part) | | | (wt part) | | Pattern |
| Ex. | PC | PS | Si Beads | MS | Si Beads | Layer |
| 19 | 800 | 200 | 1 | — | — | ◯ |
| 20 | 200 | 800 | 1 | — | — | ◯ |
| 21, 23 | 800 | 200 | — | 100 | 7 | ◯ |
| 22, 24 | 200 | 800 | — | 100 | 7 | ◯ |

PC: polycarbonate (reaction product of 2,2-bis(4-hydroxyphenyl)propane and phosgene), LG Dow, Calibre 300-22
PS: polystyrene, Toyo Styrene, HRM40
MS: styrene-acrylate copolymer resin, Nippon Steel Chemical, MS600
Si beads: silicon beads, Nikko Rica MSP-020S

The light diffusion plates thus obtained were measured for total light transmittance, haze, brightness, curling, water absorption and thermal modification temperature. The results are shown in Table 6 below.

TABLE 6

| | Total Light | | | | | |
|---|---|---|---|---|---|---|
| | Transmit- | | Bright- | | Water | Thermal |
| | tance | Haze | ness | Curling | Absorption | Deformation |
| Ex. | (%) | (%) | (cd/m²) | (mm) | (%) | Temp. (° C.) |
| 19 | 48.5 | 99 | 4583 | 0.18 | 0.19 | 121.8 |
| 20 | 47.2 | 99 | 4516 | 0.16 | 0.17 | 100.1 |
| 21 | 48.7 | 99 | 4625 | 0.18 | 0.19 | 118.2 |
| 22 | 47.6 | 99 | 4576 | 0.17 | 0.18 | 99.1 |
| 23 | 48.9 | 99 | 4654 | 0.17 | 0.18 | 118.1 |
| 24 | 48.1 | 99 | 4585 | 0.16 | 0.16 | 99.5 |

As is apparent from Table 6, the light diffusion plate having the pattern layer had total light transmittance close to 40% and high brightness.

In addition, such a diffusion plate was mounted to a 32″ backlight unit, and a diffusion film, a prism film, and a reflective polarization film were sequentially placed thereon, after which whether the image of the lamp could be observed with the naked eye was evaluated. As the results, the ability to hide the lamp was good.

1. A light diffusion plate which is composed of a base resin selected from the group consisting of a polycarbonate resin, a polystyrene resin, and mixtures thereof, said light diffusion plate having a pattern layer formed on at least one of its surfaces;
wherein the total light transmittance of the light diffusion plate is 40% or more and brightness of 4500 cd/mm².

2. A light diffusion plate, comprising:
a substrate layer formed of a base resin selected from among polycarbonate resin, polystyrene resin, and mixtures thereof;
a surface layer formed on at least one surface of the substrate layer; and
a pattern layer formed on at least one surface of the surface layer,
wherein the total light transmittance of the light diffusion plate is 40% or more and brightness of 4500 cd/mm².

3. A light diffusion plate, composed of a base resin selected from among polycarbonate resin, polystyrene resin, and mixtures thereof, said light diffusion plate having haze of 90% or less and total light transmittance of 80% or more.

4. A light diffusion plate, comprising:
a substrate layer formed of a base resin selected from among polycarbonate resin, polystyrene resin, and mixtures thereof; and
a surface layer formed on at least one surface of the substrate layer,
wherein the light diffusion plate has haze of 90% or less and total light transmittance of 80% or more.

5. The light diffusion plate according to claim 1, further comprising a light-diffusing agent having a particle size of 100 μm or less.

6. The light diffusion plate according to claim 5, wherein the light-diffusing agent is one or more selected from among acrylic polymer particles; styrene polymer particles; olefin polymer particles; acryl and styrene copolymer particles; acryl and olefin copolymer particles; styrene and olefin copolymer particles; multilayer multicomponent particles, obtained by forming homopolymer, copolymer or terpolymer particles, which are then coated with another type of monomer; siloxane polymer particles; fluorine resin particles; calcium carbonate particles; barium sulfate particles; silicon oxide particles; aluminum hydroxide particles; titanium oxide particles; zirconium oxide particles; magnesium fluoride particles; talc particles; glass particles; and mica.

7. The light diffusion plate according to claim 3, further comprising a pattern layer formed on at least one surface thereof.

8. The light diffusion plate according to claim 1, wherein the pattern layer comprises a plurality of patterns having a polyhedral shape, a cross-section of which is polygonal, semicircular, or semi-elliptical, or a column shape, a cross-section of which is polygonal, semicircular, or semi-elliptical, and the patterns are respectively arranged to be adjacent to each other or not.

9. The light diffusion plate according to claim 7, wherein the pattern layer comprises a plurality of patterns having a polyhedral shape, a cross-section of which is polygonal, semicircular, or semi-elliptical, or a column shape, a cross-section of which is polygonal, semicircular, or semi-elliptical, and the patterns are respectively arranged to be adjacent to each other or not.

10. The light diffusion plate according to claim 1, wherein the polystyrene resin has a glass transition temperature of 105° C. or higher.

11. The light diffusion plate according to claim 10, wherein the polystyrene resin is a polystyrene resin in which acrylic acid is copolymerized.

12. The light diffusion plate according to claim 2, further comprising a light-diffusing agent having a particle size of 100 μm or less.

13. The light diffusion plate according to claim 3, further comprising a light-diffusing agent having a particle size of 100 μm or less.

14. The light diffusion plate according to claim 4, further comprising a light-diffusing agent having a particle size of 100 μm or less.

15. The light diffusion plate according to claim 12, wherein the light-diffusing agent is one or more selected from among acrylic polymer particles; styrene polymer particles; olefin polymer particles; acryl and styrene copolymer particles; acryl and olefin copolymer particles; styrene and olefin copolymer particles; multilayer multicomponent particles, obtained by forming homopolymer, copolymer or terpolymer particles, which are then coated with another type of monomer; siloxane polymer particles; fluorine resin particles; calcium carbonate particles; barium sulfate particles; silicon oxide particles; aluminum hydroxide particles; titanium oxide particles; zirconium oxide particles; magnesium fluoride particles; talc particles; glass particles; and mica.

16. The light diffusion plate according to claim 13, wherein the light-diffusing agent is one or more selected from among acrylic polymer particles; styrene polymer particles; olefin polymer particles; acryl and styrene copolymer particles; acryl and olefin copolymer particles; styrene and olefin copolymer particles; multilayer multicomponent particles, obtained by forming homopolymer, copolymer or terpolymer particles, which are then coated with another type of monomer; siloxane polymer particles; fluorine resin particles; calcium carbonate particles; barium sulfate particles; silicon oxide particles; aluminum hydroxide particles; titanium oxide particles; zirconium oxide particles; magnesium fluoride particles; talc particles; glass particles; and mica.

17. The light diffusion plate according to claim 14, wherein the light-diffusing agent is one or more selected from among acrylic polymer particles; styrene polymer particles; olefin polymer particles; acryl and styrene copolymer particles; acryl and olefin copolymer particles; styrene and olefin copolymer particles; multilayer multicomponent particles, obtained by forming homopolymer, copolymer or terpolymer particles, which are then coated with another type of monomer; siloxane polymer particles; fluorine resin particles; calcium carbonate particles; barium sulfate particles; silicon oxide particles; aluminum hydroxide particles; titanium oxide particles; zirconium oxide particles; magnesium fluoride particles; talc particles; glass particles; and mica.

18. The light diffusion plate according to claim 4, further comprising a pattern layer formed on at least one surface thereof.

19. The light diffusion plate according to claim 2, wherein the pattern layer comprises a plurality of patterns having a polyhedral shape, a cross-section of which is polygonal, semicircular, or semi-elliptical, or a column shape, a cross-section of which is polygonal, semicircular, or semi-elliptical, and the patterns are respectively arranged to be adjacent to each other or not.

20. The light diffusion plate according to claim 18, wherein the pattern layer comprises a plurality of patterns having a polyhedral shape, a cross-section of which is polygonal, semicircular, or semi-elliptical, or a column shape, a cross-section of which is polygonal, semicircular, or semi-elliptical, and the patterns are respectively arranged to be adjacent to each other or not.

21. The light diffusion plate according to claim 2, wherein the polystyrene resin has a glass transition temperature of 105° C. or higher.

22. The light diffusion plate according to claim 3, wherein the polystyrene resin has a glass transition temperature of 105° C. or higher.

23. The light diffusion plate according to claim 4, wherein the polystyrene resin has a glass transition temperature of 105° C. or higher.

24. The light diffusion plate according to claim 21, wherein the polystyrene resin is a polystyrene resin in which acrylic acid is copolymerized.

25. The light diffusion plate according to claim 22, wherein the polystyrene resin is a polystyrene resin in which acrylic acid is copolymerized.

26. The light diffusion plate according to claim 23, wherein the polystyrene resin is a polystyrene resin in which acrylic acid is copolymerized.
